(19) United States
(12) Patent Application Publication
(10) Pub. No.: US 2008/0075635 A1
(43) Pub. Date: Mar. 27, 2008

(54) Pipette Holder

(76) Inventor: Hongjun Wang, Brookline, MA (US)

Correspondence Address: HONGJUN WANG, 23 HOWELL STREET, DORCHESTER, MA, 02125, US

(21) Appl. No.: 11/535,517

(22) Filed: Sep. 27, 2006

(51) Int. Cl. B01L 9/00

(52) U.S. Cl. 422/104

(57) ABSTRACT

A pipette holder, which lets the pipette slide in and out, can hold the pipette under the shelf.

### BACKGROUND

1. Technical Field

The present invention relates to a device to hold a pipette. More particularly it relates to holding a pipette under a shelf.

2. Background of the Invention

Nowadays, numerous pipette holders and stands are used in different laboratories. Typically the pipette holder is a type of stand to hold the pipette vertically. It stands on the laboratory benchtop surface, or attaches to a vertical surface via screws or an adhesive pad.

With the development of laboratory science, more and more reagents and equipment need to be put on the benchtop surface, which results in a need to free up space on the benchtop surface. Although another type of pipette holder can free up benchtop area by attaching to a vertical surface via screws or adhesive pad, these are not popular because there is not much vertical surface within arm's length that can be used for this purpose without disturbing the work routine.

### BRIEF SUMMARY OF THE INVENTION

The present invention is a type of plastic pipette holder. It can be installed on different types of shelves with screws, and the pipette will be held just beneath the shelf.

Accordingly, the present invention can hold the pipette without occupying benchtop surface, and still be within easy reach, and without disturbing the work routine.

### BRIEF DESCRIPTION OF THE DRAWINGS

FIG. 1 is an isometric view of a pipette holder fixed on a shelf, and with a pipette inside.

FIG. 2 is an isometric view of a pipette holder.

FIG. 3 is a side view of a pipette holder.

FIG. 4 is an isometric view of a pipette holder under an enhanced shelf.

### DETAILED DESCRIPTION OF THE INVENTION

Reference will now be made to the drawing figures to describe the present invention in detail.

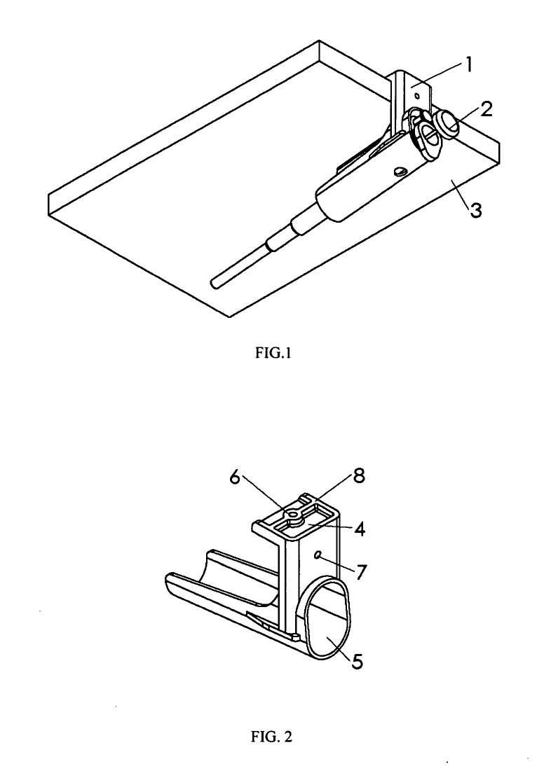

FIG. 1 illustrates a pipette holder fixed on a shelf, including a pipette holder 1, a pipette 2, and shelf 3.

Also referring to FIG. 1 and FIG. 2, the pipette holder 1 comprises a reversed L-shaped connection part 4, and a holder body 5. There is a top hole 6 on the horizontal plate of the connection part 4. The top hole 6 can be used to fix the pipette holder 1 to the shelf 3 via screw in some applications. There is a side hole 7 on the vertical plate of the connection part 4. The side hole 7 can be used to fix the pipette holder 1 to the shelf 3 via screw. The ribs 8 on the horizontal plate and ribs 9 on vertical plate, shown in FIG. 4, make the connection part 4 stronger.

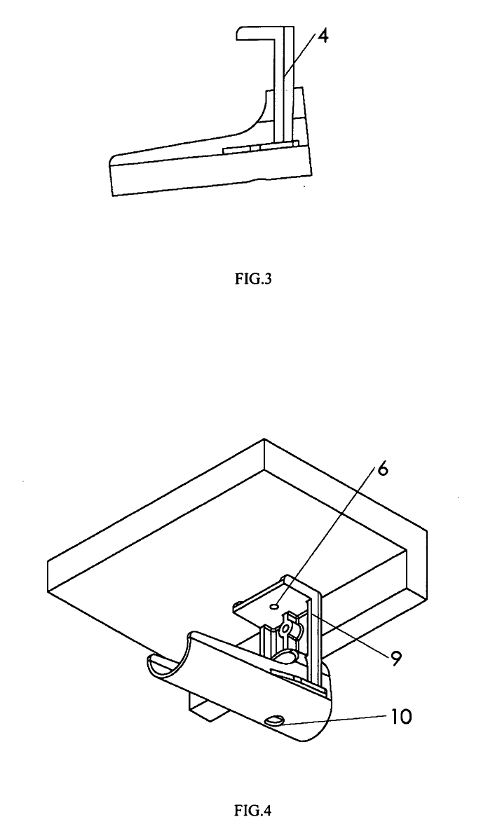

The holder body 5 is an O-shaped tube to fit the pipette; also it can allow the pipette to slide in and out. Referring to FIG. 3, the holder body 5, O-shaped tube is horizontally angled to hold the pipette. The back of O-shaped tube is half-cut to save material. Referring to FIG. 4, there is a hole 10, which is opposite to the hole 6, on the bottom of the holder body 5 to allow the screwdriver access to drive the screw in the hole 6 in certain cases.

The pipette holder is made of plastic. In installation, generally, a side screw will be used to fix the pipette holder to the shelf via side hole 7. In certain cases, referring to FIG. 4, a screw can be used to fix the pipette holder via the top hole 6, such as to fix it on shelves with ribs, or on the bottom of a cabinet.

What is claimed:

1. A pipette holder comprising a reversed L-shaped connection part, and a holder body for holding the pipette.

2. The pipette holder of claim 1, wherein it is made of plastic.

3. The pipette holder of claim 1, wherein there is a hole on the top horizontal plate of reversed L-shaped connection part.

4. The pipette holder of claim 1, wherein there is a hole on the vertical plate of reversed L-shaped connection part.

5. The pipette holder of claim 1, wherein there are ribs on the outside of horizontal plate of reversed L-shaped connection part.

6. The pipette holder of claim 1, wherein there are ribs on the inside of vertical plate of reversed L-shaped connection part.

7. The pipette holder of claim 1, wherein the holder body is an O-shaped tube as a holding pipette.

8. The pipette holder of claim 1, wherein the holder body, O-shaped tube is horizontally angled.

9. The pipette holder of claim 1, wherein the back of holder body, O-shaped tube, is half cut.

10. The pipette holder of claim 1, wherein there is a hole on the bottom of holder body O-shaped tube. This hole is opposite to the hole on the top horizontal plate of reversed L-shaped connection part.
